(19) United States
(12) Patent Application Publication
(10) Pub. No.: US 2013/0294076 A1
(43) Pub. Date: Nov. 7, 2013

(54) Light fixture

(71) Applicant: Tobias Grau, (US)

(72) Inventor: Tobias Grau, Hamburg (DE)

(73) Assignee: Tobias Grau, Hamburg (DE)

(21) Appl. No.: 13/661,408

(22) Filed: Oct. 26, 2012

(30) Foreign Application Priority Data
Oct. 28, 2011 (DE) 10 2011 117 156.1

(51) Int. Cl. F21V 7/00

(52) U.S. Cl. CPC F21V 7/0083
USPC 362/241

(57) ABSTRACT

A light fixture, such as a laminar light fixture to illuminate a workstation with an effective anti-glare feature comprising a number of LEDs as light sources, and an anti-glare grid with a number of adjacently located, anti-glare channels going through and a number of webs separating the anti-glare channels. Each anti-glare channel has a first end and a second end that is opposite to the first end. The light fixture further comprises a light-guiding panel with a number of adjacently located cup-like light-guiding elements. Each light-guiding element provides a light-guiding channel going through that has a first end and a second end that is located opposite to the first end. Further, at least one LED is located at the first end of the light-guiding channel of each light-guiding element. One light-guiding element is located in each anti-glare channel.

The present invention relates to a light fixture, in particular a laminar light fixture for use at a workstation.

Especially when illuminating workstations, it is important to implement effective anti-glare measures, as a person working at a monitor can be exposed to glare not only from the light emitted by the light source itself, but also by the light reflected by the screen surface. To avoid this type of glare, a series of anti-glare measures have already been suggested that are reflected in various anti-glare directives.

One trend in the lighting industry is to provide light fixtures with LEDs as light sources, because LEDs have a high luminous efficacy compared with traditional light sources. Because the light is generated in the semi-conductor of the LED by a small surface, today's highly efficient LEDs that are suitable for illuminating the workstation have a very high light density (e.g. 50×10̂6 cd/m̂2), so that effective anti-glare measures are especially indicated. Due to the high level of brightness of the LEDs, the glare effect is increased and reflections from the screen surface occur more frequently.

A light fixture is known from publication DE 10 2006 016 218 A1, which has a number of illumination sources in the form of LEDs. Further, on the emitting side of the illumination source, a light-diffusing plate-shaped body is provided with openings that widen toward the reflecting side. One part of the light emitted by the LEDs passes the openings of the body. A second part of the light emitted by the LEDs impinges unimpeded on the surface of the body and is guided into the plate-shaped body. A part of the light beam that is guided into the body is then reflected again diffused by the plate-shaped body as so-called secondary radiation. Although only some of the light emitted by the LEDs penetrates into the plate-shaped body and is in turn reflected by it diffusely, it has been shown that this diffused secondary radiation is so bright that it unpleasantly blinds a person that is working under such a light fixture directly or indirectly by reflections from the monitor.

The objective of the present invention therefore consists of providing a light fixture, which has an effective anti-glare feature even when highly efficient LEDs with high light density are used.

The aforementioned problem is solved by a light fixture which
provides a number of LEDs as light sources,
has an anti-glare grid with a number of adjacently located anti-glare channels going through and a number of webs separating the anti-glare channels, whereby each anti-glare channel has a first end and a second end that is opposite to the first end, and
a light-guiding panel having a number of adjacently located cup-shaped light-guiding elements, whereby each light-guiding element respectively provides a light-guiding channel going though that has a first end and a second end that is opposite to the first end.

Hereby, the anti-glare channels, the LEDs and the light-guiding channels are arranged in such a way that respectively at least one LED is located at the first end of the light guiding channel of each light-guiding element and respectively one light-guiding element is provided in each anti-glare channel in the section of the first end of the light guiding channel. The inner surface of each light guiding channel is designed in such a way that it almost completely reflects the emitted light of the respectively at least one LED located at the first end of the light guiding channel and thus guides [it] into the direction of the second end of the respective anti-glare channel, so that the surrounding webs respectively pertaining to the anti-glare channel are only weakly illuminated.

The light fixture according to the invention accordingly has—other than prior art—two components, namely the light-guiding elements of the light-guiding panel and the anti-glare channels of the anti-glare grid, which perform the guidance of the light or the anti-glare function. The task sharing by the light-guiding panel and the anti-glare grid requires significantly more effort in terms of materials and expenses, when compared with the traditional solution. But this effort is worthwhile, as the structure according to the invention achieves a significant anti-glare improvement and thus a more comfortable light is generated for the user.

The improved anti-glare effect is achieved thereby, that the light-guiding element is located at the first end of the respective anti-glare channel. As the light-guiding elements almost completely reflect the light permeating the respective light-guiding channel, in the section of the first end of the anti-glare channel, no light from the LEDs impinges on the surrounding webs. Only at the second end of the anti-glare channel, the surrounding webs are essentially illuminated by diffused light, which is generated primarily at the second end of the light-guiding channel. The greatest amount of the light emitted by the LEDs is guided by the light-guiding channels in such a way that the light penetrates the anti-glare channels without any reciprocal action with the anti-glare grid. As almost no light beam from the LEDs goes into the anti-glare grid, it can only reflect very few secondary rays, so that the anti-glare grid appears comfortably dark to a person looking in the direction of the light fixture, and creates an optimal anti-glare effect.

Further, due to the light-guiding channel inserted into the anti-glare channel, which has an opening at its second end having a smaller diameter than the anti-glare channel in this section, the direct view into the light source of the light fixture is additionally restricted so that even at an anti-glare angle of 60°, an effective anti-glare effect is achieved.

Due to the nesting of the light-guiding channels and the anti-glare channels, the walls of the webs separating the anti-glare channels can be designed almost parallel to vertical, which further reduces glare. Further, the surface of the anti-glare grid that is visible for the user from the bottom is further minimized, which likewise leads to a reduction of glare. The nesting of the light-guiding channels and the anti-glare channels furthermore has the advantage that the total height of the light fixture is not any larger when compared with traditional light fixtures, and the light fixture continues to have a flat structure.

Overall, as a result of the nesting of the light-guiding channels and the anti-glare channels, a precise control and limitation of the light density of the light emitted by the LEDs is achieved producing an effective anti-glare effect, while maintaining optimal light guidance and an optimal degree of effectiveness.

In the present invention, respectively the first end of the anti-glare channels and the first end of the light-guiding channels lie at the approximate height of the upper side of the LEDs mounted on a printed board. The second end of the light-guiding channels and the second end of the anti-glare channels are located respectively opposite to the emitting side of the LEDs, whereby the height of the light-guiding channels is lower in the direction of emission than the height of the anti-glare channels. Thereby, respectively one light-guiding channel is located in an anti-glare channel.

For one anti-glare channel and one light-guiding channel, respectively either one LED or one group of closely adjacently mounted LEDs, for example, three or four LEDs, can be provided. The use of an LED group as light source is advantageous particularly then, when due to the combination of the spectral ranges of the LEDs of a group, an especially balanced and pleasant light spectrum is to be achieved for the user.

The anti-glare grid can be transparent or opaque. For a higher opacity, the anti-glare grid can be colored. In the former case, the light fixture appears lighter outside of the viewing angle than when the anti-glare grid is colored. Even if, however, the anti-glare grid has a comparably high degree of transparency, the anti-glare grid appears only marginally brighter for the reasons explained above, as it is, aside from the diffused light, only weakly illuminated by the LEDs.

In a preferred exemplary embodiment, the inner surface of each light-guiding channel is reflecting by at least 75%, preferably at least 85%, especially preferred, it is designed white or chrome-colored. Hereby, an optimal light guidance is achieved and in the section of the light-guiding channel, the illumination of the webs of the anti-glare grid is avoided. The reflection behavior at the inner surfaces of the light-guiding channels described also has a decidedly positive influence on the degree of effectiveness of the light fixture.

An especially small amount of secondary light, i.e. the light radiation penetrating the anti-glare grid is generated by the anti-glare grid then, when the light of the LEDs is guided through the light-guiding channels in such a way that at most 10% of the primary radiation, preferably at the most 5% of the primary radiation falls on the webs surrounding the anti-glare channels. Hereby, primary radiation refers to the light of the LEDs that either comes directly from the respective LED or was reflected by the surface of the light-guiding channel.

As has already been explained above, it is advantageous if only a front section of the webs of the anti-glare grid is illuminated that is located at the second end of the respective anti-glare channel. At the front section of the webs of the anti-glare grid, these have only a small volume, so that for this reason as well, the total illumination density of the secondary radiation is reduced in the section of the anti-glare grid.

In a further preferred exemplary embodiment, the at least one LED and correspondingly the first end of each light-guiding channel is located next to the longitudinal axis of the respectively pertaining anti-glare channel. Alternatively, or additionally, the longitudinal axis of each light-guiding channel can extend inclined to the longitudinal axis of the respectively pertaining anti-glare channel. The angle of incline of the longitudinal axes toward each other is thereby at least 5°, preferably at least 15°. Due to the eccentric position of the LEDs with respect to the anti-glare channel and/or the incline of the longitudinal axis of the light-guiding channel to the longitudinal axis of the anti-glare channel, there is a displacement of the light center out of the LED axis, which leads to a broader and more homogeneous distribution of the light emitted by the LEDs. This results in a spatially more extended and more uniform illumination of the workstation that is illuminated with the light fixture according to the invention.

A further step for illuminating the workstation spatially more extended and homogeneously consists of providing the anti-glare channels and correspondingly the light-guiding channels located in them in an even number of n (for example, n=4) adjacently located rows (in the example: 4 rows). Hereby, the light-guiding channels of the n/2 rows (in the example: 2 rows) of a first side (e.g. the left side) relative to a center line have a longitudinal axis inclined toward the first side (e.g. to the left) toward the longitudinal axis of the respectively pertaining anti-glare channel and the light-guiding channels of the n/2 rows of the second side (e.g. the right side) relative to the center line (in the example: 2 rows) a longitudinal axis inclined toward the second side (e.g. towards the right) toward the longitudinal axis of the respectively associated anti-glare channel.

The anti-glare effect is particularly effective thereby, that the height of the light-guiding channels is approximately half of the height of the respectively pertaining anti-glare channels. As a result, the light guiding channels reach far into the respectively pertaining anti-glare channel and additionally reduce—due to their small diameter, as shown above, the view into the respective light source. It is further advantageous when the relationship between the wall distance at the second end of the light-guiding channel and the web distance at the end of the pertaining anti-glare channel is between 0.5 and 0.6. The smaller the second opening located at the second end of the light-guiding channel in the direction of reflection, the larger is the anti-glare angle that is important for visual comfort. However, an opening that is too small at the second end of the light-guiding channel limits the homogeneity of the light generated by the light fixture and the light emitted by the LEDs is focused too strongly. Hereby, wall distance means the distance of the diametrically opposite wall centers of the light-guiding channel at its second end, and web distance means the distance of diametrically opposite web centers at the second end of the anti-glare channels.

Due to the use of a large number of at least 180 LEDs for a light fixture, preferably at least 230 LEDs, especially preferred at least 480 LEDs, the problem of multiple shadows is reduced beyond recognition.

Further features, advantages and possibilities of applications of the invention result from the following description of an exemplary embodiment of a light fixture according to the invention and the Figures. Thereby, all described and/or figuratively illustrated features by themselves or in any combination, are the subject matter of the present invention, even independent of their summary in the claims or their references.

Schematically shown are:

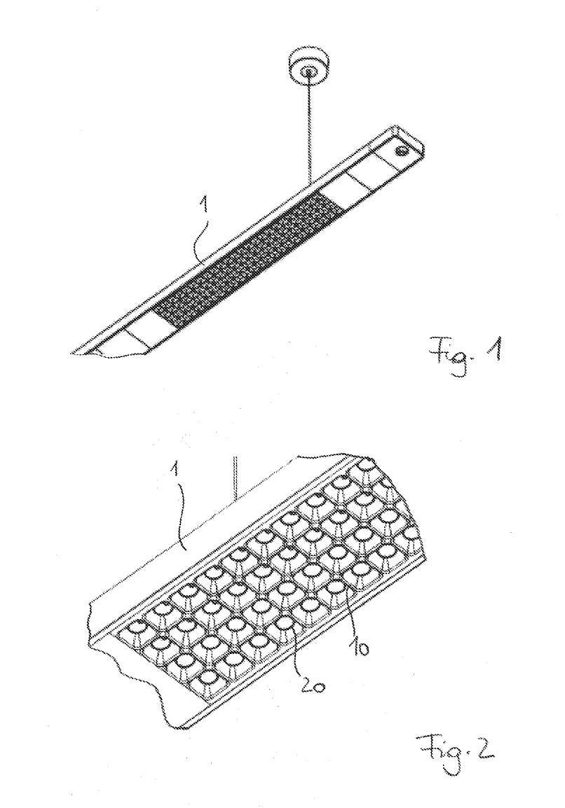

FIG. 1 a perspective view of a light fixture according to the invention at an angle from below,

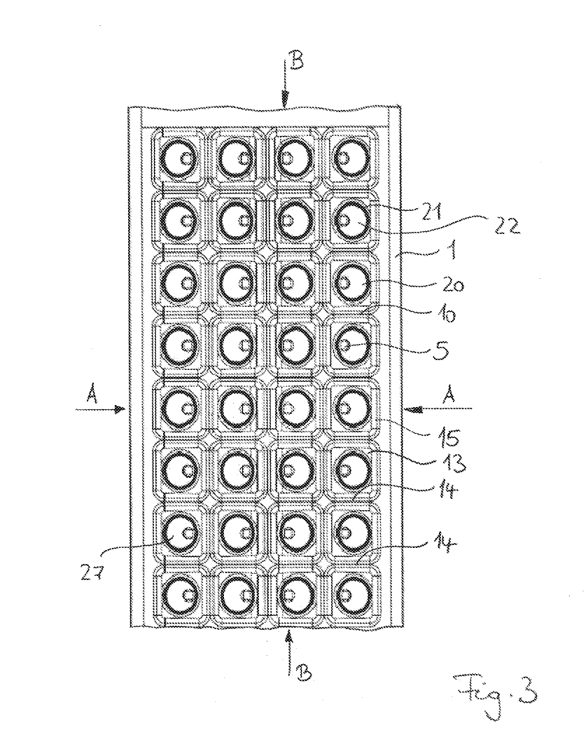

FIG. 2 an enlarged cut-out of the light fixture shown in FIG. 1,

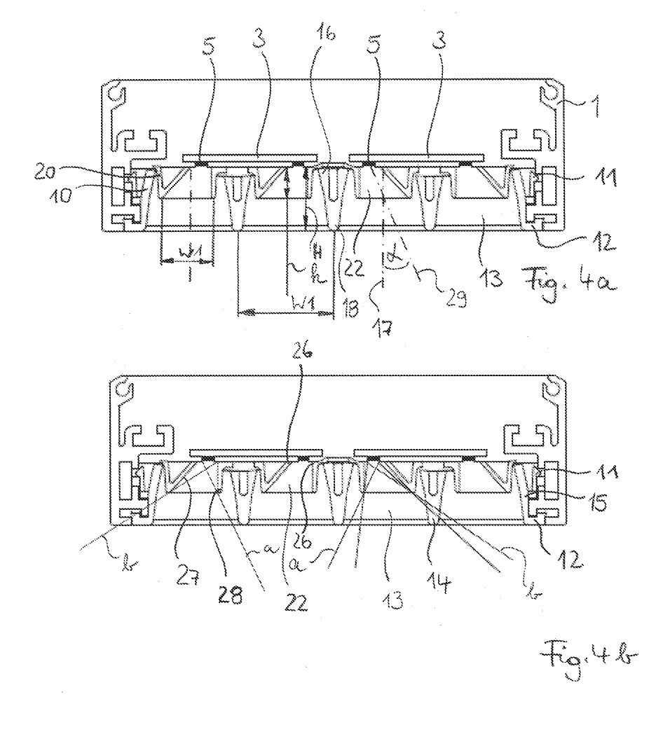

FIG. 3 a view of the light fixture shown in FIG. 1 from the bottom,

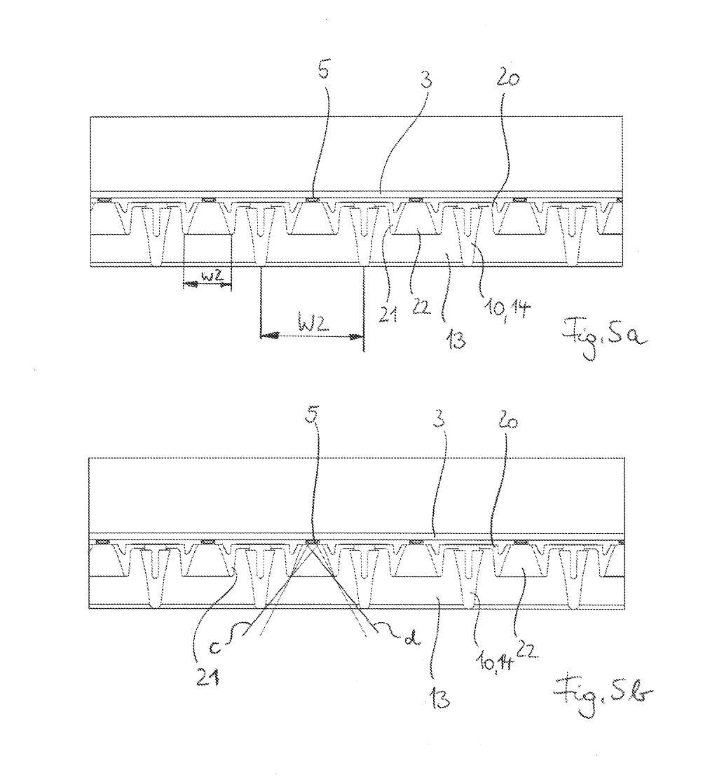

FIGS. 4a and 4b respectively the same cross section through the important elements of the light fixture for generating the illumination according to FIG. 1 extending along direction A-A (see FIG. 3) with and without illustrated border rays a, b and

FIGS. 5a and 5b respectively the same cross section through the important elements for generating the illumination of the light fixture according to FIG. 1 extending along direction B-B (see FIG. 3) without and with illustrated border rays c, d.

The cut-out of the hanging office lamp shown in FIGS. 1 and 2 has a housing 1. In the lower section of housing 1, two printed boards 3 are provided having a number of LEDs 5, an anti-glare grid 10 and a light-guiding panel 20. Printed boards 3 are mounted using a holding plate—not shown—at housing 1. In the direction of emission above printed boards 3, light-guiding panel 20 is located, which is inserted into anti-glare grid 10, and which is retained by anti-glare grid 10. It is mounted at housing 1 by using engaging pawls 11 and protrusions 12 mounted at anti-glare grid 10.

The light fixture according to the invention has four rows of adjacent LEDs 5, whereby respectively two rows of the LEDs 5 are formed by one printed board 3. Each LED 5 has an associated light-guiding element 21 of light-guiding panel 20, and an anti-glare channel 13 of anti-glare grid 10. Correspondingly, the anti-glare grid contains four rows of adjacently located anti-glare channels 13 that respectively have—at their emission side—a symmetric, approximately quadratic opening and slightly expand in the direction of emission, approximately in the shape of a parabola. Anti-glare channels 13 are separated from one another by webs 14 that form the walls of anti-glare channels 13. The respectively outer anti-glare channels 13 are also limited on the outside by anti-glare grid walls 15 abutting at housing 1.

Each cup-shaped, light-guiding element 21 of light-guiding panel 20 respectively has one light-guiding channel 22 going through that likewise widens in the direction of emission. Analogous to anti-glare channels 13, light-guiding panel 20 forms four rows of adjacently located light-guiding elements 21.

Light-guiding panel 20 is mounted in such a way that the first end 26 of the light-guiding channel 22 is located approximately in the section of the upper side of LEDs 5. Further, the light-guiding panel is inserted into the anti-glare grid 10 in such a way, that the light-guiding element 21 is located at the first end 16 of anti-glare channel 13, whereby the first end 16 of the anti-glare channel 13 and the first end 26 of the light-guiding channel 22 are positioned approximately at the height in the area of the upper side of LEDs 5.

The inner surface 27 of light-guiding channel 22 is, for example, designed glossy white or chrome-coated, so that at least 75% of the impinging light of the respective LED 5 is reflected. The light guiding panel 20 consists, for example, of ASA plastic (acrylic ester styrene acrylonitrile) and can have a chromium layer in the case of a chrome-coated inner surface 27 of the light-guiding channels 22.

The anti-glare grid 10, in particular, its webs 14 and/or walls 15 consist, for example, of a transparent material, for example, PC plastic (polycarbonate).

The inner surface 27 of light-guiding channel 22 is formed as an asymmetric free-form surface, which displaces the light center of the light fixture, in particular, in the transverse direction, out of the axis of the LED 5. This can be seen particularly in FIG. 4b, in which the border rays a, b of the light emitted by LED 5 are illustrated. It can be seen that the light radiation of the two LED rows that are left of the center line is guided outward to the left, while the light of LEDs 5 of the two rows to the right of the center line is guided outward to the right. This results in a spatially extended illumination of the workstation.

Further, each LED 5 is located next to the longitudinal axis 17 of the respective anti-glare channel 13, and that specifically in the two left rows of FIGS. 4a and 4b on the right next to longitudinal axis 17, and in the two rows of LEDs 5 positioned on the right of the center line, on the left next to longitudinal axis 17 of the respective anti-glare channel 13.

It can be derived from the run of border rays a, b of the cross section shown in FIG. 4b through the light fixture according to the invention that only in the respective direction outward (border ray b) light from the LED 5 impinges directly on a front end of webs 14 or walls 15. Border ray a that is directed inward does not impinge on a web 14 or a wall 15.

It can be seen in FIG. 5b that on the other hand, that the inner surface 27 of light-guiding channel 22 is designed symmetric in the longitudinal direction of the light fixture, as the edge rays c, d are inclined to approximately the same degree.

It can be derived from the run of edge rays c, d of the longitudinal cross section shown in FIGS. 5a and 5b through the light fixture according to the invention it is evident that in addition to the diffused radiation that is always present, which is formed primarily at second end 28 of light guiding channel 22, no direct light from LED 5 falls on webs 14 or walls 15 of anti-glare grid 10 in the longitudinal direction.

Due to the shape of inner surface 27 of light guiding channel 22, at most 10% of the primary radiation impinges to respective webs 14 or walls 15 of anti-glare grid 10—primarily into the direction transverse and outwards to the light fixture (border rays b).

In the exemplary embodiment shown in FIGS. 5a and 5h, only one LED 5 is associated with one light-guiding channel 22 and one anti-glare channel 13. Alternatively, one light guiding channel 22 and one anti-glare channel 13 can be associated with a group of LEDs 5 that are located directly adjacent to each other.

It is further shown in FIG. 4a that longitudinal axis 29 of light guiding channel 22 extends inclined by an angle α of at least 5°, preferably at least 15°, to longitudinal axis 17 of anti-glare channel 13. Hereby, the longitudinal axes 29 of the two left rows of the light-guiding channels 22 are inclined by an angle α to the left of longitudinal axis 17 of anti-glare channel 13, while the two right rows of the light-guiding channels 22 are inclined by an angle α to the right with respect to longitudinal axis 17 of anti-glare channel 13.

The height h of light-guiding element 21 or light-guiding channel 22 is, for example, approximately 8.5 mm, and the height H of anti-glare channel 13, for example, approximately 16 mm. Consequently the height h of light-guiding channel 22 is more than half the height H of the pertaining anti-glare channel 13.

The wall distance w1 at second end 28 of light guiding channel 22 in the trans-verse direction is, for example, approximately 12 mm and the web distance W1 of anti-glare channel 13 at its second end 18 is approximately 22 mm in the same direction. The relationship between wall distance w1 and web distance W1 is therefore approximately 0.55 in the transverse direction.

In the longitudinal direction shown in FIGS. 5a and 5b the relationship of wall distance w2 to web distance W2 is approximately 0.56, whereby w2 is approximately 14 mm and W2 approximately 25 mm.

Overall, the light fixture according to the invention described above and illustrated in the Figures achieves, due to the two-part design (light-guiding panel 20 anti-glare grid 10) of the components for guiding light and for anti-glare and by the nesting of these components, an effective anti-glare effect with an anti-glare angle of 60° to 65°, while maintaining optimal light guiding and a high degree of effectiveness.

### REFERENCE NUMBERS

1 housing
3 printed board
5 LED
10 anti-glare grid
11 engaging pawl
12 protrusion
13 anti-glare channel
14 web
15 wall
16 first end of the anti-glare channel 13
17 longitudinal axis of the anti-glare channel 13
18 second end of the anti-glare channel 13
20 light-guiding panel
21 light-guiding element
22 light-guiding channel
26 first end of the light-guiding channel 22
27 inner surface of the light-guiding channel 22
28 second end of the light-guiding channel 22
29 longitudinal axis of the light-guiding channel 22
a, b, c, d border/edge rays
h height of the light-guiding channel 22
H height of the anti-glare channel 13
w1, w2 wall distance of light guiding element 21
W1, W2 web distance

What is claimed is:

1. A light fixture, in particular, a laminar light fixture to illuminate a workstation,
having a number of LEDs (5) as light sources,
having an anti-glare grid (10) with a number of adjacently located, anti-glare channels (13) going through and a number of webs (14) separating the anti-glare channels (13), whereby each anti-glare channel (13) has a first end (16) and a second end (18) that is opposite to the first end, and
having a light-guiding panel (20) with a number of adjacently located cup-like light-guiding elements (21), whereby each light-guiding element respectively provides a light-guiding channel (22) going through that has a first end (26) and a second end (28) that is located opposite to the first end,
whereby, respectively at least one LED (5) is located at the first end (26) of the light guiding-channel (22) of each light-guiding element (21) and respectively one light-guiding element (21) is located in each anti-glare channel (13) in the section of the first end (16) of the anti-glare channel (13), whereby the inner surface (27) of each light-guiding channel (22) is designed in such a way that it almost completely reflects the light emitted by the at least one LED that is respectively located at the first end (26) of the light-guiding channel (22) and guides it into the direction of the second end (18) of the respective anti-glare channel (13) in such a way that the webs (14) surrounding the respectively pertaining anti-glare channel (13) are only weakly illuminated.

2. A light fixture as recited in claim 1, wherein the inner surface (27) of each light-guiding channel (22) is designed reflecting at least 75%, preferably white or chrome-colored.

3. A light fixture as recited in one of the preceding claims, wherein at most 10% of the primary radiation impinges on the webs (14) surrounding the anti-glare channels (13).

4. A light fixture as recited in one of the preceding claims, wherein only an anterior section of the webs (14) of the anti-glare grid (10) is illuminated that is located at the second end (18) of the respective anti-glare channel (13).

5. A light fixture as recited in one of the preceding claims, wherein the material of the webs (14) of the anti-glare channel (13), is transparent or opaque.

6. A light fixture as recited in one of the preceding claims, wherein the at least one LED (5) is located next to the longitudinal axis (17) of the respectively pertaining anti-glare channel (13).

7. A light fixture as recited in one of the preceding claims, wherein the longitudinal axis (29) of each light-guiding channel (22) extends inclined to the longitudinal axis of the respectively pertaining anti-glare channel (13).

8. A light fixture as recited in one of the preceding claims, wherein the anti-glare channels (13) and correspondingly the light-guiding channels (22) located therein are provided in an even number of n adjacently located rows, whereby the light-guiding channels (22) of the n/2 rows of a first side relative to a center line have a longitudinal axis (29) inclined to the first side toward the longitudinal axis (17) of the respectively associated anti-glare channel (13), and the light-guiding channels (22) of the n/2 rows of the second side relative to the center line have a longitudinal axis (29) inclined to the second side toward longitudinal axis (17) of the respectively associated anti-glare channel (13).

9. A light fixture as recited in one of the preceding claims, wherein the height (h) of the light-guiding channel (22) is approximately half the height (H) of the respectively pertaining anti-glare channel (13).

10. A light fixture as recited in one of the preceding claims, wherein the relationship between the wall distance (w1, w2) at the second end (28) of the light-guiding channel (22) and the web distance (W1, W2) at the second end (18) of the pertaining anti-glare channel (13) is between 0.5 and 0.6.

11. A light fixture according to one of the preceding claims, wherein the light fixtures has at least 180 LEDs (5).
